(19) United States
(12) Patent Application Publication
(10) Pub. No.: US 2026/0208783 A1
(43) Pub. Date: Jul. 23, 2026

(54) ELECTRODE DEVICE

(71) Applicant: Panasonic Automotive Systems Co., Ltd., Kanagawa (JP)

(72) Inventors: Yasuhiro YAMASHITA, Osaka (JP); Hideaki ETO, Osaka (JP)

(73) Assignee: Panasonic Automotive Systems Co., Ltd., Kanagawa (JP)

(21) Appl. No.: 19/420,182

(22) Filed: Dec. 15, 2025

(30) Foreign Application Priority Data
Jan. 23, 2025 (JP) 2025-010044

(51) Int. Cl. B62D 1/06; G01L 5/22; G06F 3/044

(52) U.S. Cl. CPC B62D 1/06; G01L 5/221; G06F 3/0448

(57) ABSTRACT

An electrode device to be disposed on a rim of steering wheel provided in vehicle includes a first base material having a sheet form, a first bonding layer laminated on the first base material, a conductive base fabric laminated on the first bonding layer, a second bonding layer laminated on the conductive base fabric, and a conductive elastomer laminated on the conductive base fabric so as not to overlap the second bonding layer. The second bonding layer is laminated with an outer cover material having formed therein a slit for exposing the conductive elastomer, and the conductive elastomer is disposed in the slit.

### CROSS REFERENCE TO RELATED APPLICATION

The present application is based on and claims priority of Japanese Patent Application No. 2025-010044 filed on January 23, 2025.

### FIELD

The present disclosure relates to an electrode device.

### BACKGROUND

As a related technique, there is known a conductive rubber-coated fabric that measures a heartbeat signal of a driving driver from an electrode provided in a vehicle’s steering wheel.

For example, Patent Literature (PTL) 1 discloses a conductive rubber-coated fabric that can be used as a biosensing electrode. The conductive rubber-coated fabric includes a conductive base fabric layer formed by a conductive base fabric and having a first conductive base fabric layer surface, and a conductive rubber layer formed by laminating conductive rubber on the first conductive base fabric layer surface.

### Citation List

### Patent Literature

PTL 1: International Patent Publication No. 2022/075129

### SUMMARY

However, the conductive rubber-coated fabric according to PTL 1 can be improved upon.

In view of this, the present disclosure provides an electrode device capable of improving upon the above related art.

An electrode device according to one aspect of the present disclosure is an electrode device to be disposed on a rim of a steering wheel provided in a vehicle, and the electrode device includes: a first base material having a sheet form; a first bonding layer laminated on the first base material; a conductive base fabric laminated on the first bonding layer; a second bonding layer laminated on the conductive base fabric; and a conductive elastomer laminated on the conductive base fabric, the conductive elastomer not overlapping the second bonding layer, wherein the second bonding layer is laminated with an outer cover material having formed therein a slit for exposing the conductive elastomer, and the conductive elastomer is disposed in the slit.

The electrode device according to the present disclosure is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a schematic diagram showing one example of a vehicle in which a steering wheel according to an embodiment is provided.

FIG. 2 is a sectional view showing a state in which an electrode device wrapped around a rim is electrically connected to a wire.

FIG. 3 is a plan view showing an electrode device according to the embodiment.

FIG. 4 is a sectional view showing the electrode device, taken along the A-A line indicated in FIG. 3

FIG. 5 is an exploded perspective view showing the electrode device according to the embodiment.

FIG. 6 is a block diagram showing the electrode device according to the embodiment.

FIG. 7 is a plan view showing an electrode device according to the embodiment provided with a conductive elastomer having a wavy line shape.

FIG. 8A is a sectional view showing an electrode device according to the embodiment that includes a conductive elastomer having an inclined surface formed thereon and an outer cover material having an uneven structure formed therein.

FIG. 8B is a sectional view of an electrode device according to the embodiment in which the surface of a conductive elastomer is flush with the surface of an outer cover material.

FIG. 9 is a plan view showing an electrode device according to the embodiment in which a plurality of grip detecting electrodes are provided.

FIG. 10 is another plan view showing the electrode device according to the embodiment in which the plurality of grip detecting electrodes are provided.

FIG. 11 is another plan view showing an electrode device according to the embodiment in which a plurality of grip detecting electrodes and a shield electrode are provided.

FIG. 12 is a plan view showing an electrode device according to the embodiment further provided with a heater wire.

FIG. 13 is a plan view showing an electrode device according to the embodiment further provided with a plurality of grip detecting electrodes, a shield electrode, a second base material, and a heater wire.

FIG. 14 is a sectional view showing the electrode device according to the embodiment further provided with the plurality of grip detecting electrodes, the shield electrode, the second base material, and the heater wire.

FIG. 15 is a plan view showing an electrode device according to the embodiment further provided with a plurality of grip detecting electrodes, a conductive wire (a shield electrode), a second base material, and a heater wire.

FIG. 16 is a sectional view showing the electrode device according to the embodiment further provided with the plurality of grip detecting electrodes, the conductive wire (the shield electrode), the second base material, and the heater wire.

FIG. 17 is a diagram showing the range of a conductive elastomer disposed on a rim in its neutral position.

### DESCRIPTION OF EMBODIMENT

Hereinafter, an embodiment will be described in concrete terms with reference to the drawings.

It is to be noted that the embodiment described below merely illustrates general or specific examples. The numerical values, the shapes, the materials, the constituent elements, the arrangement positions and the connection modes of the constituent elements, and so on illustrated according to the following embodiment are examples and are not intended to limit the present disclosure. In addition, among the constituent elements described according to the following embodiment, any constituent elements that are not cited in the independent claim are to be construed as optional constituent elements.

Furthermore, the drawings are schematic diagrams and do not necessarily provide exact depictions. In addition, in the drawings, any constituent elements that are identical are given identical reference characters.

In the following description of the embodiment, expressions such as “T shape” or “T-shaped” are used. For example, the expression “T shape” means not only that an element is shaped exactly like the letter T but also that an element is shaped substantially like the letter T. In other words, this expression allows for an error of several percentages. Furthermore, the expression “T shape” means that an element is T-shaped within the range in which the advantageous effects of the present disclosure can be achieved. The explanation above applies in a similar manner to other expressions with the term “shape” or “shaped”.

### Embodiment

### Configuration

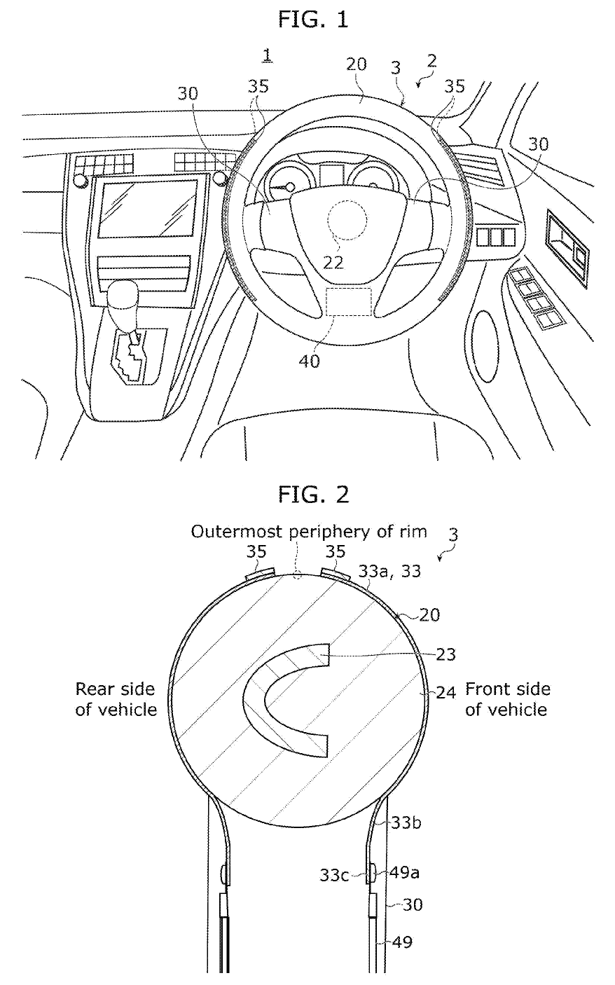

First, steering wheel 2 provided in vehicle 1 will be described with reference to FIG. 1 to FIG. 6.

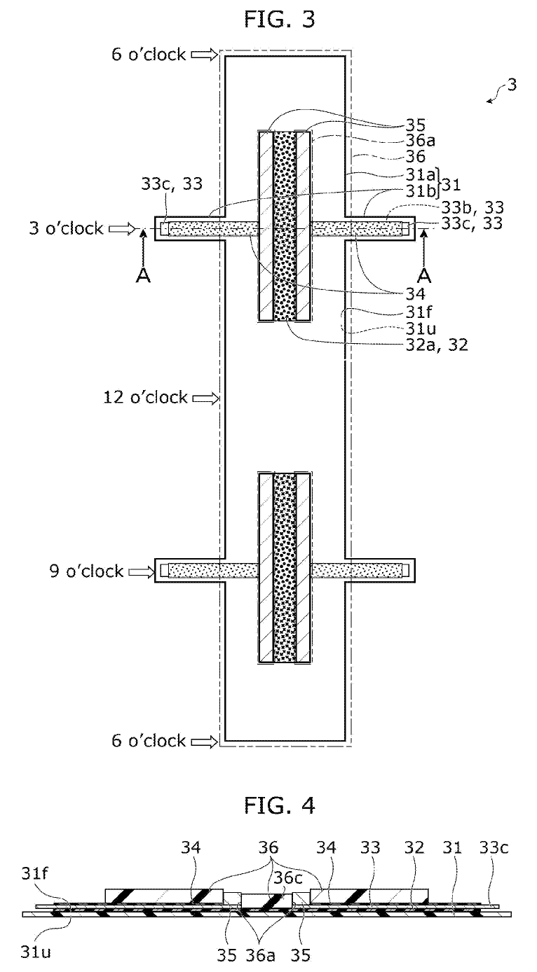

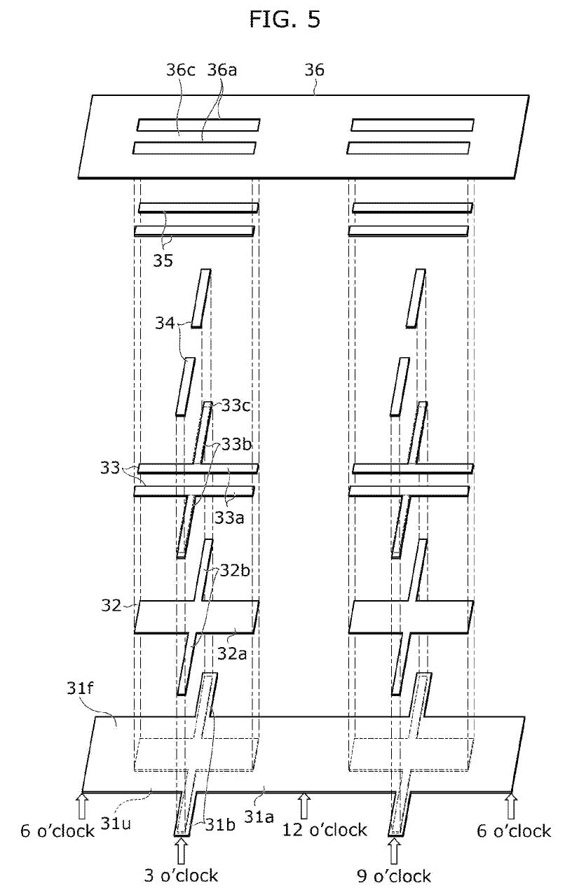

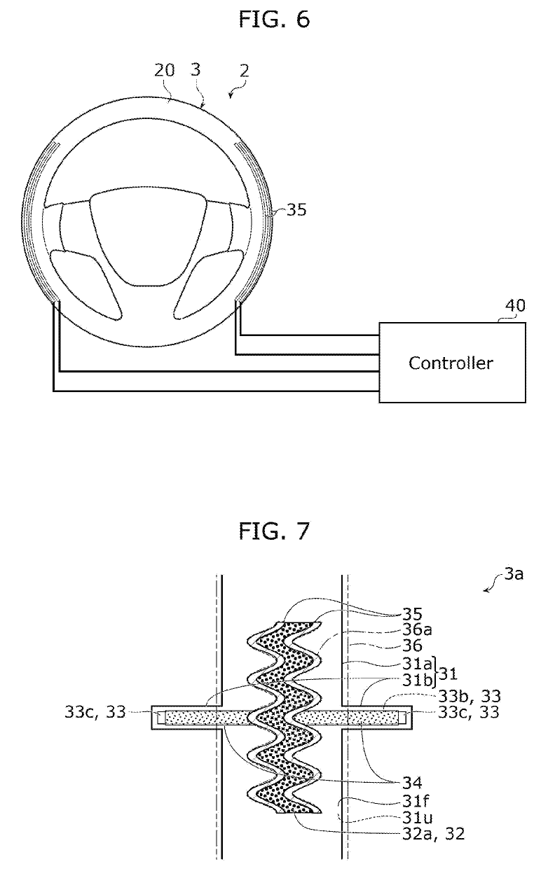

FIG. 1 is a schematic diagram showing one example of vehicle 1 in which steering wheel 2 according to an embodiment is provided. FIG. 2 is a sectional view showing a state in which electrode device 3 wrapped around rim 20 is electrically connected to wire 49. FIG. 2 omits first base material 31, first bonding layer 32, a pair of second bonding layers 34, and outer cover material 36 so as to simplify the drawing. FIG. 3 is a plan view showing electrode device 3 according to the embodiment. The markings “3 o’clock”, “6 o’clock”, “9 o’clock”, and “12 o’clock” shown in FIG. 3 correspond to the positions on electrode device 3 wrapped around rim 20, with rim 20 in its neutral position viewed as a clock. The same markings may be used in the drawings in and following FIG. 5. FIG. 3 shows the edges of outer cover material 36 in the dashed-two-dotted lines so as to clearly show the arrangement of first base material 31, first bonding layer 32, conductive base fabrics 33, second bonding layers 34, and conductive elastomers 35. The edges of outer cover material 36 may be indicated by dashed-two-dotted lines in the drawings in and following FIG. 3 as well. FIG. 4 is a sectional view showing electrode device 3, taken along the A-A line indicated in FIG. 3. FIG. 5 is an exploded perspective view showing electrode device 3 according to the embodiment. FIG. 6 is a block diagram showing electrode device 3 according to the embodiment.

As shown in FIG. 1 and FIG. 2, steering wheel 2 can provide a steering angle to the steered wheels of vehicle 1. Steering wheel 2 includes rim 20, spoke 30, hub 22, electrode device 3, and controller 40.

Rim 20 is a gripping part where the driver (a person) grips rim 20 with his or her hands. Rim 20 shown in FIG. 1 has, for example, a ring shape. It is to be noted that the shape of rim 20 is not limited to a ring shape, and rim 20 may have any shape, such as a yoke shape, a D shape, or an elliptical shape.

Electrode device 3 is wrapped around rim 20 and spoke 30. Electrode device 3 includes electrode device 3 that is wrapped around rim 20 and electrode device 3 that is wrapped around spoke 30. Electrode device 3 can be separated from rim 20, but electrode device 3 can be formed integrally with rim 20.

As shown in FIG. 2, rim 20 includes metal core 23 and foam 24 that covers metal core 23.

Foam 24 constitutes the outer shell of rim 20 of steering wheel 2. Foam 24 is made of a urethane resin material, such as polyurethane. Foam 24 embeds metal core 23 therein.

As shown in FIG. 1, spoke 30 is a support member that connects rim 20 and hub 22. Spoke 30 is also formed by metal core 23 and foam 24 that covers metal core 23. Spoke 30 is disposed on the inner circumferential surface of rim 20. Spoke 30, connected to rim 20, forms a T shape along with rim 20.

Specifically, as shown in FIG. 1 and FIG. 3, when rim 20 in its neutral position is viewed as a clock, spoke 30 on the right side extends in the 3-o’clock direction from hub 22, spoke 30 on the left side extends in the 9-o’clock direction from hub 22, and spoke 30 on the lower side extends in the 6-o’clock direction from hub 22.

Hub 22 is a member that transmits the rotary force produced as rim 20 is operated to the steering shaft and is located in the center portion of steering wheel 2.

Electrode device 3 is provided on steering wheel 2 of vehicle 1. Electrode device 3 is capable of detecting biometric information of the driver touching steering wheel 2 while the driver grips steering wheel 2 with his or her hands. The driver’s biometric information includes information indicating the heart rate of the driver touching steering wheel 2 and information indicating the perspiration state of the driver touching steering wheel 2.

Next, a specific configuration of electrode device 3 will be described.

As shown in FIG. 1 and FIG. 3, electrode device 3 includes first base material 31, first bonding layer 32, a pair of conductive base fabrics 33, a pair of second bonding layers 34, and a pair of conductive elastomers 35. Second bonding layers 34 are laminated with outer cover material 36. In this example, electrode device 3 may further include outer cover material 36.

According to the present embodiment, while first base material 31 and outer cover material 36 are disposed on the entire periphery of ring-shaped rim 20, first bonding layer 32, the pair of conductive base fabrics 33, second bonding layers 34, and conductive elastomers 35 are disposed on a portion of rim 20. For example, according to the present embodiment, when rim 20 in its neutral position is viewed as a clock, first bonding layer 32, the pair of conductive base fabrics 33, and second bonding layers 34, and conductive elastomers 35 are disposed on the area of rim 20 that corresponds to the range of from around 2 o’clock to around 4 o’clock and the area of rim 20 that corresponds to the range of from around 8 o’clock to around 10 o’clock. These areas correspond to the positions where the driver may grip rim 20 with his or her hands.

First base material 31 has an elongated sheet form that extends along the outer periphery of rim 20. First base material 31 is wrapped around the surfaces of rim 20 and spoke 30. First base material 31 is formed, for example, of a resin material, such as polyethylene or polyurethane.

As shown in FIG. 1, FIG. 3, and FIG. 5, first base material 31 includes base material rim portion 31a and a pair of base material spoke portions 31b. Herein, the “pair” of base material spoke portions 31b is shown in FIG. 5 such that the element denoted by the reference character 31b is branched into two. This statement applies also to the other elements referenced as forming a “pair”.

Base material rim portion 31a is a belt-shaped sheet that is disposed on the surface of rim 20 and that extends in the direction in which rim 20 extends.

The pair of base material spoke portions 31b each extends from base material rim portion 31a in the direction that intersects with the lengthwise direction of base material rim portion 31a. When electrode device 3 is wrapped around rim 20, one base material spoke portion 31b of the pair of base material spoke portions 31b extends along spoke 30 and covers the front side of spoke 30. Meanwhile, other base material spoke portion 31b of the pair of base material spoke portions 31b extends along spoke 30 and covers the back side of spoke 30. The front side of spoke 30 faces toward the rear of vehicle 1, and the back side of spoke 30 faces toward the front of vehicle 1.

Although illustration is omitted, one pair of base material spoke portions 31b is disposed on spoke 30 on the right side, and another pair of base material spoke portions 31b is disposed on spoke 30 on the left side.

As shown in FIG. 1 and FIG. 3 to FIG. 5, first bonding layer 32 is laminated on front surface 31f of first base material 31. Front surface 31f of first base material 31 is the side opposite to its side facing rim 20 (i.e., back surface 31u of first base material 31). First bonding layer 32 is, for example but not limited to, a double-sided adhesive tape or an adhesive.

First bonding layer 32 includes first bonding rim portion 32a and a pair of first bonding spoke portions 32b.

First bonding rim portion 32a extends in the lengthwise direction of base material rim portion 31a and is laminated on the surface of base material rim portion 31a. As shown in FIG. 1 and FIG. 3, when electrode device 3 is wrapped around rim 20, first bonding rim portion 32a is disposed on the area of base material rim portion 31a that corresponds to the range of from around 2 o’clock to around 4 o’clock and the area of base material rim portion 31a that corresponds to the range of from around 8 o’clock to around 10 o’clock.

As shown in FIG. 1 and FIG. 3 to FIG. 5, the pair of first bonding spoke portions 32b is laminated, one to one, on the surfaces of the pair of base material spoke portions 31b such that each of the pair of first bonding spoke portions 32b extends along corresponding one of the pair of base material spoke portions 31b. The pair of first bonding spoke portions 32b each extends in the direction that intersects with the lengthwise direction of first bonding rim portion 32a.

One first bonding spoke portion 32b of the pair of first bonding spoke portions 32b is laminated on the surface of one of the pair of base material spoke portions 31b. Other first bonding spoke portion 32b of the pair of first bonding spoke portions 32b is laminated on the surface of the other of the pair of base material spoke portions 31b.

Although the illustration is omitted, one pair of first bonding spoke portions 32b is disposed on spoke 30 on the right side, and another pair of first bonding spoke portions 32b is disposed on spoke 30 on the left side.

Each of the pair of conductive base fabrics 33 is a T-shaped base fabric. The pair of conductive base fabrics 33 is laminated on a portion of first bonding layer 32 with the pair of conductive base fabrics 33 located apart from each other. The pair of conductive base fabrics 33 is bonded to front surface 31f of first base material 31 with first bonding layer 32 therebetween.

Each of the pair of conductive base fabrics 33 includes base fabric rim portion 33a and base fabric spoke portion 33b. In other words, a pair of base fabric rim portions 33a and a pair of base fabric spoke portions 33b are laminated on one first bonding layer 32. Base fabric rim portion 33a and base fabric spoke portion 33b are electrically connected. Base fabric rim portion 33a and base fabric spoke portion 33b may be formed integrally or may be separate elements. Base fabric rim portion 33a and base fabric spoke portion 33b may be joined together as they are sewn together using conductive machine thread or the like, or base fabric rim portion 33a and base fabric spoke portion 33b may be joined together by a conductive adhesive or a conductive tape.

The pair of base fabric rim portions 33a each extends in the lengthwise direction of first bonding rim portion 32a and is laminated on the surface of first bonding rim portion 32a. The pair of base fabric rim portions 33a is disposed on the surface of one first bonding rim portion 32a with the pair of base fabric rim portions 33a located apart from each other. As shown in FIG. 1, FIG. 3, and FIG. 5, when electrode device 3 is wrapped around rim 20, base fabric rim portions 33a are disposed on the area of first bonding rim portion 32a that corresponds to the range of from around 2 o’clock to around 4 o’clock and the area of first bonding rim portion 32a that corresponds to the range of from around 8 o’clock to around 10 o’clock.

Specifically, the pair of base fabric spoke portions 33b are laminated, one to one, on the surfaces of the pair of first bonding spoke portions 32b. Base fabric spoke portions 33b each extend from corresponding base fabric rim portion 33a in the direction that intersects with the lengthwise direction of base fabric rim portion 33a and in which first bonding spoke portion 32b extends One base fabric spoke portion 33b of the pair of base fabric spoke portions 33b is laminated on the surface of one of the pair of first bonding spoke portions 32b. Other base fabric spoke portion 33b of the pair of base fabric spoke portions 33b is laminated on the surface of the other of the pair of first bonding spoke portions 32b.

Each of the pair of base fabric spoke portions 33b is electrically connected to wire 49, shown in FIG. 2, via wire connector 33c. Wire 49 is electrically connected to controller 40 shown in FIG. 6.

When electrode device 3 is wrapped around rim 20, one conductive base fabric 33 of the pair of conductive base fabrics 33 is disposed on the area of steering wheel 2 that faces toward the front of vehicle 1. Other conductive base fabric 33 of the pair of conductive base fabrics 33 is disposed on the area of steering wheel 2 that faces toward the rear of vehicle 1.

Although illustration is omitted, one pair of conductive base fabrics 33 is disposed on spoke 30 on the right side, and another pair of conductive base fabrics 33 is disposed on spoke 30 on the left side.

As shown in FIG. 1 and FIG. 3 to FIG. 5, the pair of second bonding layers 34 are laminated on the surfaces of the pair of conductive base fabrics 33 and extend in the direction that intersects with the direction in which rim 20 extends. The stated surfaces of conductive base fabrics 33 are on the sides opposite to their sides that face first bonding layer 32. The pair of second bonding layers 34 is, for example but not limited to, a double-sided adhesive tape or an adhesive.

Specifically, the pair of second bonding layers 34 are laminated, one to one, on the pair of base fabric spoke portions 33b, except at wire connectors 33c that are electrically connected to the corresponding ones of the pair of base fabric spoke portions 33b. One second bonding layer 34 of the pair of second bonding layers 34 is laminated on the surface of one of the pair of base fabric spoke portions 33b, except at wire connector 33c that is electrically connected to the one of the pair of base fabric spoke portions 33b. Other second bonding layer 34 of the pair of second bonding layers 34 is laminated on the surface of the other of the pair of base fabric spoke portions 33b, except at wire connector 33c that is electrically connected to the other of the pair of base fabric spoke portions 33b. Therefore, each of wire connectors 33c can be electrically connected to wire 49 shown in FIG. 2. Wire connectors 33c are electrically connected to wires 49, for example, by tightening portions 49a formed by a rivet, solder, or the like.

When electrode device 3 is wrapped around rim 20, one of the pair of second bonding layers 34 is disposed in the area of steering wheel 2 that faces toward the front of vehicle 1, and the other of the pair of second bonding layers 34 is disposed in the area of steering wheel 2 that faces toward the rear of vehicle 1.

Although illustration is omitted, one pair of second bonding layers 34 is disposed on spoke 30 on the right side, and another pair of second bonding layers 34 is disposed on spoke 30 on the left side.

As shown in FIG. 1 and FIG. 3 to FIG. 5, the pair of conductive elastomers 35 each form an elongated belt-shaped layer that extends in the direction in which rim 20 extends. The pair of conductive elastomers 35 is laminated, one to one, on the surfaces of the pair of conductive base fabrics 33 and disposed so as not to overlap the pair of second bonding layers 34. The pair of conductive elastomers 35 are laminated, one to one, on the pair of base fabric rim portions 33a, and as the pair of conductive elastomers 35 fills fine gaps present in the pair of base fabric rim portion 33a, the pair of conductive elastomers 35 is tightly bonded to the pair of base fabric rim portions 33a. Therefore, the pair of conductive elastomers 35 is electrically connected, one to one, to the pair of base fabric rim portions 33a.

The pair of conductive elastomers 35 extends in the direction in which rim 20 extends and is disposed such that the pair of conductive elastomers 35 is adjacent to each other but not in contact with each other. In this example, that the pair of conductive elastomers 35 is disposed adjacent to each other means, for example, that the space between the pair of conductive elastomers 35 is narrower than the thickness of the driver’s fingers so that the fingers can make contact throughout with the pair of conductive elastomers 35 when his or her hands come into contact with steering wheel 2.

As shown in FIG. 1, FIG. 3, and FIG. 5, when electrode device 3 is wrapped around rim 20, the pair of conductive elastomers 35 is disposed on the area of the pair of base fabric rim portions 33a that corresponds to the range of from around 2 o’clock to around 4 o’clock and the area of the pair of base fabric rim portions 33a that corresponds to the range of from around 8 o’clock to around 10 o’clock.

As shown in FIG. 2, when viewing a cross-section of rim 20, the pair of conductive elastomers 35 is disposed on rim 20 such that the outermost periphery of rim 20 indicated by the dashed line passes between the pair of conductive elastomers 35. In other words, when electrode device 3 is wrapped around rim 20, one conductive elastomer 35 of the pair of conductive elastomers 35 is disposed on the area of steering wheel 2 that faces toward the front of vehicle 1. Other conductive elastomer 35 of the pair of conductive elastomers 35 is disposed on the area of steering wheel 2 that faces toward the rear of vehicle 1.

Although illustration is omitted, one pair of conductive elastomers 35 is disposed on the right side of rim 20 as rim 20 in its neutral position is viewed from the front, and another pair of conductive elastomers 35 is disposed on the left side of rim 20 as rim 20 in its neutral position is viewed from the front. In this example, the right side and the left side of rim 20 as rim 20 in its neutral position is viewed from the front may also be referred to simply as the right side and the left side of rim 20.

Outer cover material 36 has an elongated sheet form that extends in the direction in which rim 20 extends. Outer cover material 36 is disposed so as to extend in the direction in which rim 20 extends. Outer cover material 36 is laminated on first base material 31. Outer cover material 36 covers a laminated body composed of first bonding layer 32, the pair of conductive base fabrics 33, the pair of second bonding layers 34, and the pair of conductive elastomers 35 laminated on first base material 31 such that the pair of conductive elastomers 35 is exposed through outer cover material 36.

Outer cover material 36 has formed therein a pair of slits 36a that allows the pair of conductive elastomers 35 to be exposed. The pair of slits 36a is formed in outer cover material 36 such that slits 36a correspond, one to one, to the pair of conductive elastomers 35 in position and in size. The pair of slits 36a is disposed in a state in which the pair of conductive elastomers 35 is disposed therein. When electrode device 3 is wrapped around rim 20, the pair of slits 36a is formed in outer cover material 36 such that the pair of slits 36a overs the area of rim 20 that corresponds to the range of from around 2 o’clock to around 4 o’clock and the area of rim 20 that corresponds to the range of from around 8 o’clock to around 10 o’clock.

Although illustration is omitted, one pair of slits 36a is disposed on the right side of rim 20, and another pair of slits 36a is disposed on the left side of rim 20.

In the laminated body, the portion of first bonding layer 32 located between the pair of conductive elastomers 35 is exposed. Therefore, belt-shaped portion 36c of outer cover material 36 that is located between the pair of slits 36a is bonded to the exposed portion of first bonding layer 32. Furthermore, since second bonding layers 34 are also exposed, outer cover material 36 is bonded to second bonding layers 34 as well. The portions surrounding the pair of slits 36a are fixed by first bonding layer 32 and second bonding layers 34, and the orientation of the pair of slits 36a is retained such that the pair of slits 36a correspond, one to one, to the pair of conductive elastomers 35. Therefore, the pair of slits 36a is less likely to become misaligned with the pair of conductive elastomers 35.

According to the present embodiment, the surfaces of the pair of conductive elastomers 35 may be flush with the surface of outer cover material 36. In other words, there is no step between the surfaces of the pair of conductive elastomers 35 and the surface of outer cover material 36, and the height of the surfaces of conductive elastomers 35 and the height of the surface of outer cover material 36 may be designed such that the driver does not experience any sense of discomfort even when he or she touches the boundary between conductive elastomers 35 and outer cover material 36 with his or her hands. In this example, that there is no step means not only that there is completely no step but also that there is substantially no step. For example, according to the present embodiment, a step of less than 1 mm is considered to be flush.

Furthermore, according to the present embodiment, the thickness of conductive elastomers 35 can be adjusted so that the height of the surfaces of conductive elastomers 35 and the height of the surface of outer cover material 36 become substantially the same. Therefore, the surfaces of the pair of conductive elastomers 35 can be made flush with the surface of outer cover material 36.

Controller 40 shown in FIG. 6 may detect, for example but not limited to, the heart rate and the perspiration state of the driver based on the biometric information detected by the pair of conductive elastomers 35.

For example, one of conductive elastomers 35 disposed on the right side of rim 20 or the left side of rim 20 may serve as a heartbeat detecting electrode, and the other of conductive elastomers 35 disposed on the right side of rim 20 or the left side of rim 20 may serve as a reference electrode. Furthermore, one of conductive elastomers 35 disposed on the left side of rim 20 or the right side of rim 20 may serve as a heartbeat and perspiration detecting electrode, and the other of conductive elastomers 35 disposed on the left side of rim 20 or the right side of rim 20 may serve as a perspiration detecting electrode.

In this case, controller 40 may include a heartbeat detecting circuit (not shown) and a perspiration detecting circuit (not shown).

The heartbeat detecting circuit is a heart rate monitor that, upon the driver’s hand making contact with steering wheel 2, detects the driver’s heart rate. The heartbeat detecting circuit detects the driver’s heart rate based on signals output from the heartbeat detecting electrode, the heartbeat and perspiration detecting electrode, and the reference electrode, and can thus obtain information indicating the driver’s heart rate.

The heartbeat detecting circuit is constituted, for example but not limited to, by a low pass filter, a differential amplifier, and an analog-to-digital (A/D) converter. The heartbeat detecting circuit inputs a heartbeat signal to an electronic control unit (ECU) provided in vehicle 1. With this configuration, the ECU can obtain information indicating the driver’s heart rate. For example, the ECU can display the information indicating the driver’s heart rate on an in-vehicle monitor provided in vehicle 1.

The perspiration detecting circuit is a perspiration detector that, upon the driver’s hand making contact with steering wheel 2, can detect the perspiration state of the driver’s hand. The perspiration detecting circuit can detect the perspiration state of the driver’s hand as perspiration signals output from the perspiration detecting electrode and the heartbeat and perspiration detecting electrode are input to the perspiration detecting circuit.

The perspiration detecting circuit is constituted, for example but not limited to, by a low pass filter, a differential amplifier, and an A/D converter. The perspiration detecting circuit inputs a perspiration signal to an ECU provided in vehicle 1. With this configuration, the ECU can obtain information indicating the driver’s perspiration state. For example, the ECU can display the information indicating the driver’s perspiration state on an in-vehicle monitor provided in vehicle 1.

According to controller 40 configured as described above, the driver’s emotion can be estimated based on the driver’s heart rate and perspiration state. Based on the driver’s emotion estimated by controller 40, the ECU can control the in-vehicle equipment provided in vehicle 1. Examples of such in-vehicle equipment include, but are not limited to, in-vehicle air conditioning equipment, in-vehicle audio equipment, and in-vehicle lighting equipment.

Controller 40 and electrode device 3 configured as described above may constitute a measuring system provided in steering wheel 2.

Next, as shown in FIG. 7, each of a pair of conductive elastomers 35 may be configured as follows.

FIG. 7 is a plan view showing electrode device 3a according to the embodiment provided with conductive elastomers 35 having a wavy line shape.

Conductive elastomers 35 described above each have a linear shape that extends in the lengthwise direction of base fabric rim portion 33a, but this is not a limiting example. Conductive elastomers 35 may each have a wavy line shape that extends in the direction in which rim 20 extends.

In this case, each slit 36a in outer cover material 36 may have such a wavy line shape that matches the shape of each of conductive elastomers 35. Furthermore, base fabric rim portions 33a may each have such a wavy line shape as well that matches the shape of each of conductive elastomers 35.

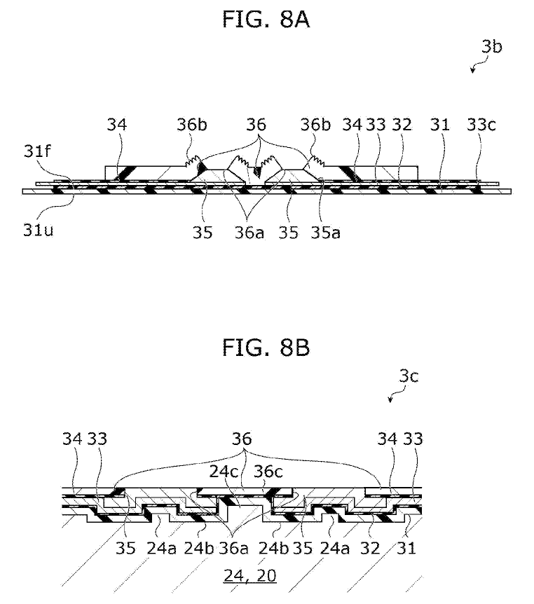

Next, as shown in FIG. 8A, each of a pair of conductive elastomers 35 may be configured as follows.

FIG. 8A is a sectional view showing electrode device 3b according to the embodiment that includes conductive elastomers 35 each having inclined surface 35a and outer cover material 36 having uneven structures 36b formed therein.

Conductive elastomer 35 may have inclined surface 35a formed at its end. Inclined surface 35a may be formed at each of the outer peripheral ends of conductive elastomer 35 or may be formed only at a portion of conductive elastomer 35. A portion of outer cover material 36 may be laminated on inclined surface 35a.

Outer cover material 36 may have uneven structures 36b formed in its surface where the driver’s hands come into contact with outer cover material 36. Uneven structures 36b are formed at positions that correspond to the positions of inclined surfaces 35a of conductive elastomers 35, that is, formed at positions that overlap the positions of inclined surfaces 35a of conductive elastomers 35. Uneven structure 36b may be a structure formed by an embossing process or may be a structure composed of recessed portions and protruding portions formed to stimulate acupoints in the driver’s fingers and palms. Uneven structures 36b are formed to surround respective slits 36a.

Next, as shown in FIG. 8B, electrode device 3c and rim 20 may be configured as follows.

FIG. 8B is a sectional view showing electrode device 3c according to the embodiment in which the surfaces of conductive elastomers 35 are flush with the surface of outer cover material 36.

As shown in FIG. 8B, the outer peripheral ends of the pair of conductive elastomers 35 may be covered by outer cover material 36 so that the surfaces of the pair of conductive elastomers 35 become flush with the surface of outer cover material 36. In this case, the surface of rim 20, that is, the surface of foam 24 may have recessed portions 24b, first protruding portions 24a, and second protruding portion 24c formed therein. For example, first protruding portions 24a may be formed on the surface of foam 24 at positions that correspond to the positions of the pair of conductive elastomers 35 exposed from steering wheel 2. Furthermore, recessed portions 24b may be formed in the surface of foam 24 so as to surround first protruding portion 24a. Furthermore, second protruding portion 24c may be formed in the surface of foam 24 at a position that corresponds to the position of belt-shaped portion 36c of outer cover material 36. The height of second protruding portion 24c may be greater than the height of first protruding portion 24a as conductive elastomers 35 and conductive base fabrics 33 are not disposed on second protruding portion 24c.

Herein, recessed portions 24b, first protruding portions 24a, and second protruding portion 24c formed in or on the surface of rim 20 are merely an example, and the present disclosure is not limited to the present embodiment.

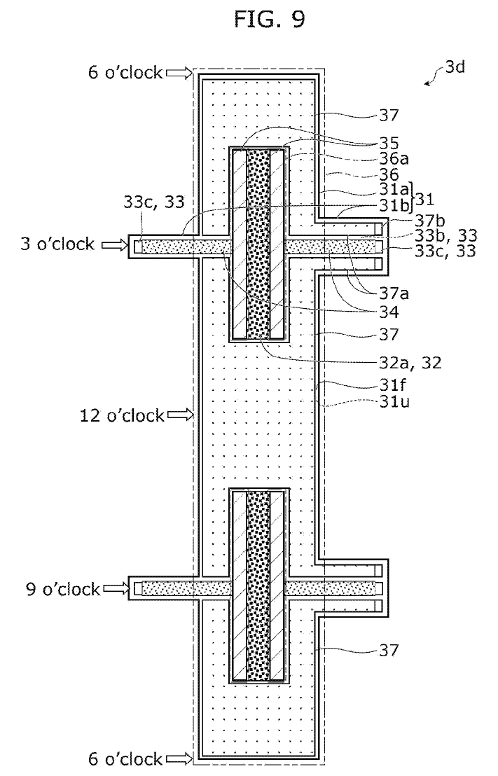

Next, as shown in FIG. 9, electrode device 3d may further include grip detecting electrode 37.

FIG. 9 is a plan view showing electrode device 3d according to the embodiment in which a plurality of grip detecting electrodes 37 are disposed.

Grip detecting electrode 37 is a sensor electrode that detects a touch on steering wheel 2 by the driver’s hand. Herein, a touch means not only a direct touch on outer cover material 36 by the driver’s hand but also an indirect touch with an object interposed therebetween and a state in which the driver’s hand is not in contact with outer cover material 36 as long as grip detecting electrode 37 can detect the driver’s hand.

Grip detecting electrodes 37 may be disposed on front surface 31f of first base material 31 so as not to make contact with the pair of conductive elastomers 35 and may extend in the direction in which rim 20 extends. Grip detecting electrodes 37 may, for example, be bonded to first base material 31 by first bonding layer 32. Space is provided between grip detecting electrodes 37 and the pair of conductive elastomers 35 and the pair of conductive base fabrics 33 so that grip detecting electrodes 37 are not in contact with the pair of conductive elastomers 35 and the pair of conductive base fabrics 33.

Furthermore, grip detecting electrodes 37 may be disposed on the entire periphery of rim 20. For example, base fabric spoke portions 33b are disposed over front surface 31f of first base material 31 at the 3-o’clock position of rim 20 that corresponds to spoke 30 on the right side and at the 9-o’clock position that corresponds to spoke 30 on the left side. Therefore, grip detecting electrodes 37 may be disposed on front surface 31f of first base material 31 in the range of rim 20 that corresponds to the range of from around 3 o’clock to around 6 o’clock, the range of rim 20 that corresponds to the range of from around 3 o’clock to around 9 o’clock, and the range of rim 20 that corresponds to the range of from around 9 o’clock to around 6 o’clock.

Outer cover material 36 may be laminated on grip detecting electrodes 37 so as to cover the entirety of grip detecting electrodes 37 in a state in which the pair of conductive elastomers 35 is exposed through outer cover material 36. In this case as well, outer cover material 36 may be disposed such that the surfaces of the pair of conductive elastomers 35 are flush with the surface of outer cover material 36.

The amount of deformation (the amount of distortion) per unit area of conductive elastomers 35 produced by a tensile stress may be smaller than the amount of deformation (the amount of distortion) per unit area of grip detecting electrodes 37 produced by this tensile stress. In other words, the Young's modulus of conductive elastomers 35 may be greater than the Young's modulus of grip detecting electrodes 37. Electrode device 3d is wrapped around rim 20 with electrode device 3d being stretched. Since conductive elastomers 35 easily deform at this point, conductive elastomers 35 can be kept from becoming misaligned.

Base material spoke portion 31b disposed on the back side of spoke 30 when electrode device 3d is wrapped around rim 20 has electrode coupler 37a disposed thereon to electrically connect grip detecting electrode 37 and wire connector 37b. Wire connector 37b is electrically connected, for example, to wire 49, shown in FIG. 2, by tightening portion 49a formed by a rivet, solder, or the like. Wire connector 37b is electrically connected to controller 40 via wire 49. Electrode coupler 37a may be formed integrally with grip detecting electrode 37 or may be a separate element that can be separated from grip detecting electrode 37. Electrode coupler 37a may be formed integrally also with wire connector 37b or may be a separate element that can be separated from wire connector 37b.

Controller 40 may further include a grip detecting circuit.

The grip detecting circuit may be a grip detector that detects a touch on electrode device 3d by the driver’s hand based on a detection signal output from grip detecting electrode 37. The grip detecting circuit may be able to determine whether the driver’s hand is in contact with electrode device 3d based on a change in the electrostatic capacity between the driver’s hand and grip detecting electrode 37. Furthermore, the grip detecting circuit may be able to detect the position where the driver’s hand has touched with the use of the plurality of grip detecting electrodes 37.

The grip detecting circuit may output a detection result corresponding to a detection signal of each of grip detecting electrodes 37. For example, the grip detecting circuit may input, for example to an ECU, a detection result indicating that the driver’s hand is in contact with electrode device 3d. With this configuration, the ECU can obtain the detection result indicating that the driver’s hand is in contact with electrode device 3d. For example, the ECU can display information indicating that the driver’s hand is not in contact with steering wheel 2 on an in-vehicle monitor provided in vehicle 1.

Controller 40 and electrode device 3d configured as described above may constitute a measuring system provided in steering wheel 2.

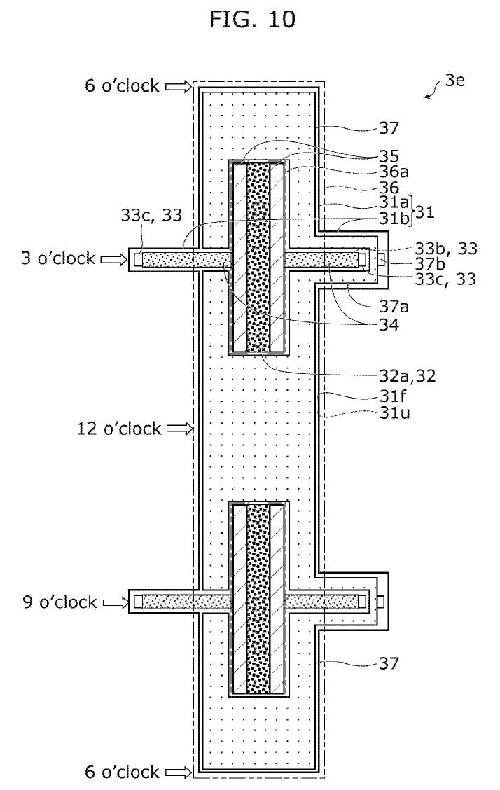

Next, as shown in FIG. 10, in electrode device 3e, a plurality of grip detecting electrodes 37 disposed on first base material 31 may be electrically connected to each other.

FIG. 10 is another plan view showing electrode device 3e according to the embodiment in which a plurality of grip detecting electrodes 37 are disposed.

Grip detecting electrode 37 disposed on rim 20 in the range of from around 3 o’clock to around 6 o’clock may be electrically connected to grip detecting electrode 37 disposed on rim 20 in the range of from around 3 o’clock to around 9 o’clock by electrode coupler 37a. Meanwhile, grip detecting electrode 37 disposed on rim 20 in the range of from around 3 o’clock to around 9 o’clock may be electrically connected to grip detecting electrode 37 disposed on rim 20 in the range of from around 9 o’clock to around 6 o’clock by electrode coupler 37a. Electrode couplers 37a are disposed on respective base material spoke portions 31b so as not to come into contact with base fabric spoke portions 33b. Space is provided between electrode coupler 37a and corresponding base fabric spoke portion 33b.

Controller 40 and electrode device 3e configured as described above may constitute a measuring system provided in steering wheel 2.

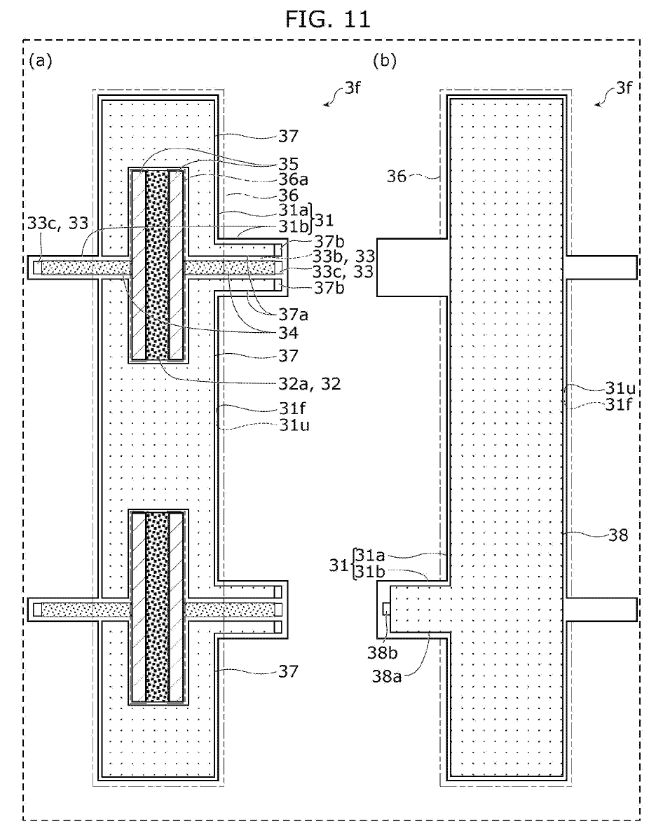

Next, as shown in FIG. 11, electrode device 3f may further include shield electrode 38.

FIG. 11 is another plan view showing electrode device 3f according to the embodiment in which a plurality of grip detecting electrodes 37 and shield electrode 38 are disposed. In FIG. 11, (a) is a plan view showing the side of front surface 31f of first base material 31. In FIG. 11, (b) is a plan view showing the side of back surface 31u of first base material 31.

Shield electrode 38 may be a belt-shaped electrode that extends in the direction in which rim 20 extends. Shield electrode 38 may be disposed on back surface 31u of first base material 31 so as to extend in the lengthwise direction of first base material 31 and such that shield electrode 38 corresponds to grip detecting electrode 37 disposed on front surface 31f of first base material 31. When electrode device 3f is wrapped around rim 20, shield electrode 38 is disposed between first base material 31 and metal core 23 of rim 20.

Shield electrode 38 may be electrically connected to controller 40. In this case, when detecting a touch on steering wheel 2 by the driver’s hand, controller 40 may apply an alternating current voltage to grip detecting electrode 37, and apply an alternating current voltage that is in phase with the alternating current voltage being applied to grip detecting electrode 37 to shield electrode 38 so as to cancel or reduce the electrostatic capacity between grip detecting electrode 37 and metal core 23 of rim 20. This configuration makes it possible to reduce the possibility that an electrostatic capacity is created between grip detecting electrode 37 and metal core 23 of rim 20. Therefore, the accuracy of detecting a touch on steering wheel 2 by the driver’s hand can be kept from being compromised.

Controller 40 and electrode device 3f configured as described above may constitute a measuring system provided in steering wheel 2.

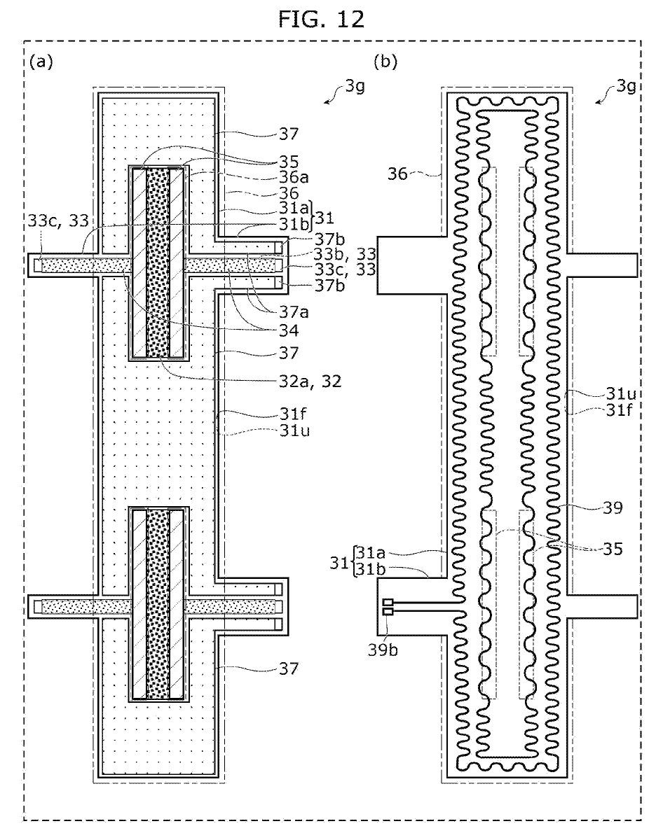

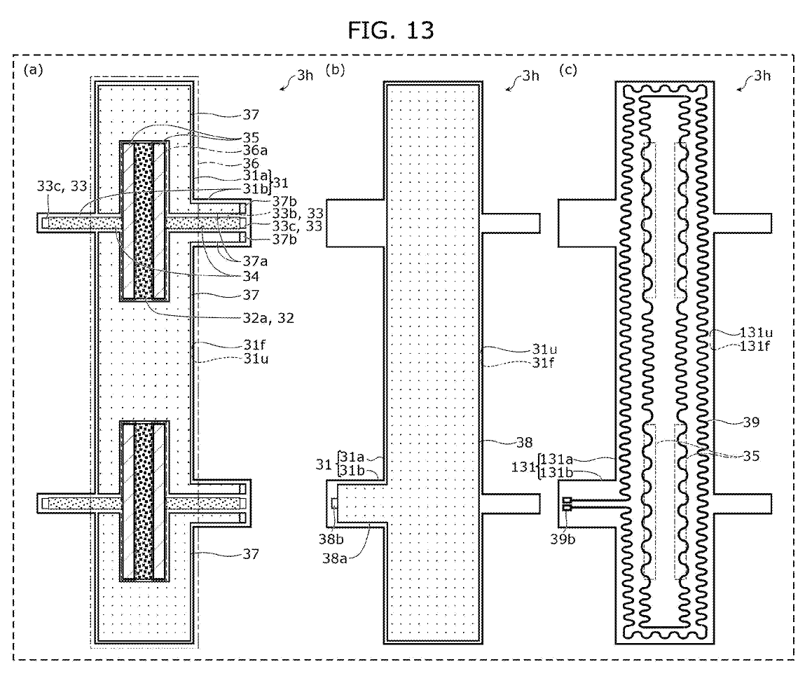

Next, as shown in FIG. 12, electrode device 3g may further include heater wire 39 that can heat steering wheel 2.

FIG. 12 is a plan view showing electrode device 3g according to the embodiment further provided with heater wire 39. In FIG. 12, (a) is a plan view showing the side of front surface 31f of first base material 31. In FIG. 12, (b) is a plan view showing the side of back surface 31u of first base material 31.

Heater wire 39 may be disposed in a zigzag shape on back surface 31u of first base material 31. In other words, heater wire 39 may be disposed between first base material 31 and foam 24 of rim 20. In this case, as shown in (b) of FIG. 12, the density per unit area of heater wire 39 in the regions in which heater wire 39 overlaps conductive elastomers 35 may be smaller than the density per unit area of heater wire 39 in the regions in which heater wire 39 does not overlap conductive elastomers 35. This configuration makes it possible to reduce a fluctuation in the overall temperature of steering wheel 2 that could be caused by conductive elastomers 35 that conduct heat readily. As a result, the overall temperature of steering wheel 2 can be expected to stay uniform.

Heater wire 39 may be electrically connected to wire connector 39b. Wire connector 39b is electrically connected, for example, to wire 49, shown in FIG. 2, by tightening portion 49a formed by a rivet, solder, or the like. Wire connector 39b may be electrically connected to controller 40 via wire 49. In this case, controller 40 may further include a feeder circuit for supplying electric power to heater wire 39. Electric power may be supplied to the feeder circuit from a power source provided in vehicle 1. Wire connector 39b may be disposed on the back surface of base material spoke portion 31b.

Furthermore, heater wire 39 may be made to function as a conductive wire that serves as a shield electrode. In other words, controller 40 may create a time division between a first period in which a touch on steering wheel 2 is detected and a second period in which the conductive wire emits heat.

For example, when detecting a touch on steering wheel 2, controller 40 may apply an alternating current voltage to grip detecting electrode 37 only during the first period, and apply an alternating current voltage that is in phase with the alternating current voltage being applied to grip detecting electrode 37 to the conductive wire only during the first period so as to cancel or reduce the electrostatic capacity between grip detecting electrode 37 and metal core 23 of rim 20.

For example, when causing the conductive wire to emit heat, controller 40 may cause the conductive wire to emit heat by applying a direct current voltage to the conductive wire only during the second period.

Meanwhile, electrode device 3g shown in (a) of FIG. 12 may be replaced with electrode device 3e shown in FIG. 10. In other words, as shown in (a) of FIG. 12, grip detecting electrodes 37 may be disposed distributedly on front surface 31f of first base material 31 between a plurality of ranges such that grip detecting electrodes 37 are electrically independent of each other. Furthermore, as shown in FIG. 10, a plurality of grip detecting electrodes 37 may be disposed on front surface 31f of first base material 31 in a state in which the plurality of grip detecting electrodes 37 are electrically integrated with each other as the plurality of grip detecting electrodes 37 are electrically connected to each other by wire connectors 37b.

Controller 40 and electrode device 3g configured as described above may constitute a measuring system provided in steering wheel 2.

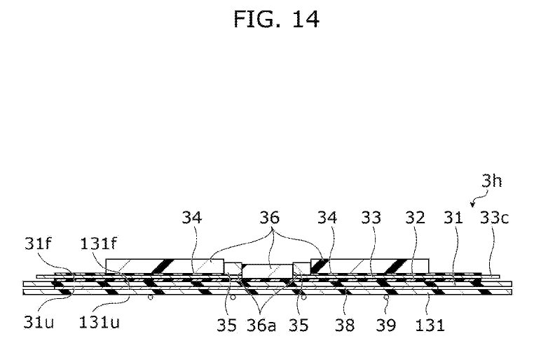

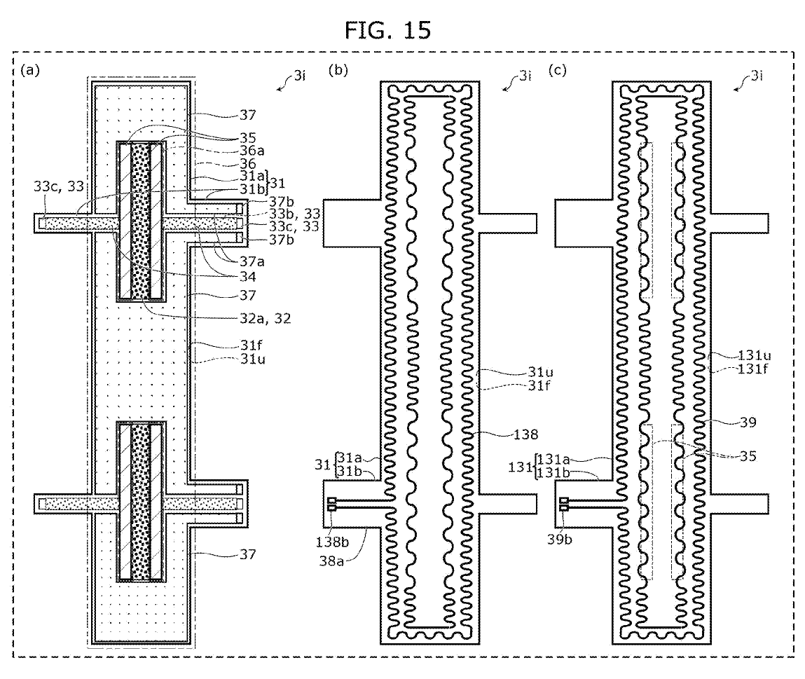

Next, as shown in FIG. 13 and FIG. 14, electrode device 3h may further include heater wire 39, shield electrode 38, and second base material 131.

FIG. 13 is a plan view showing electrode device 3h according to the embodiment further provided with a plurality of grip detecting electrodes 37, shield electrode 38, second base material 131, and heater wire 39. In FIG. 13, (a) is a plan view showing the side of front surface 31f of first base material 31. In FIG. 13, (b) is a plan view showing the side of back surface 31u of first base material 31. In FIG. 13, (c) is a plan view showing the side of back surface 131u of second base material 131. FIG. 14 is a sectional view showing electrode device 3h according to the embodiment further provided with the plurality of grip detecting electrodes 37, shield electrode 38, second base material 131, and heater wire 39.

Shield electrode 38 and second base material 131 may be disposed on back surface 31u of first base material 31.

Shield electrode 38 may be disposed on back surface 31u of first base material 31 and sandwiched between first base material 31 and second base material 131. The configuration and the function of shield electrode 38 are substantially the same as the configuration and the function described above.

Second base material 131 may have an elongated sheet form that extends along the outer periphery of rim 20. Second base material 131 may be wrapped around the surfaces of rim 20 and spoke 30. Second base material 131 may be formed of, for example, a resin material, such as polyethylene or polyurethane. Second base material 131 may have a configuration that is substantially the same as the configuration of first base material 31.

Shield electrode 38 may be disposed on front surface 131f of second base material 131. In this case, shield electrode 38 does not need to be disposed on back surface 31u of first base material 31. Heater wire 39 may be disposed on second base material 131 on its side opposite to the side where shield electrode 38 is disposed (i.e., back surface 131u of second base material 131).

Heater wire 39 may be disposed in a zigzag shape on back surface 131u of second base material 131. The configuration and the function of heater wire 39 are substantially the same as the configuration and the function described above.

Meanwhile, electrode device 3d shown in FIG. 9 or electrode device 3e shown in FIG. 10 may be applied to electrode device 3h. In other words, as shown in FIG. 9, grip detecting electrodes 37 may be disposed distributedly on front surface 31f of first base material 31 between a plurality of ranges such that grip detecting electrodes 37 are electrically independent of each other. Furthermore, as shown in FIG. 10, a plurality of grip detecting electrodes 37 may be disposed on front surface 31f of first base material 31 in a state in which the plurality of grip detecting electrodes 37 are electrically integrated with each other as the plurality of grip detecting electrodes 37 are electrically connected to each other by wire connectors 37b.

Controller 40 and electrode device 3h configured as described above may constitute a measuring system provided in steering wheel 2.

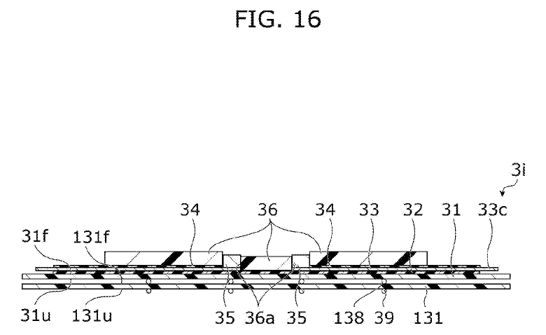

Next, as shown in FIG. 15 and FIG. 16, electrode device 3i may further include heater wire 39, a shield electrode, and second base material 131. Herein, the shield electrode may be conductive wire 138 like a heater wire. Conductive wire 138 may be electrically connected to wire connector 138b.

FIG. 15 is a plan view showing electrode device 3i according to the embodiment further provided with a plurality of grip detecting electrodes 37, conductive wire 138, second base material 131, and heater wire 39. In FIG. 15, (a) is a plan view showing the side of front surface 31f of first base material 31. In FIG. 15, (b) is a plan view showing the side of back surface 31u of first base material 31. In FIG. 15, (c) is a plan view showing the side of back surface 131u of second base material 131. FIG. 16 is a sectional view showing electrode device 3i according to the embodiment further provided with the plurality of grip detecting electrodes 37, conductive wire 138 (the shield electrode), second base material 131, and heater wire 39.

Conductive wire 138 may be disposed in a zigzag shape on back surface 131u of second base material 131. Conductive wire 138 may function as the shield electrode described above. The projection area of conductive wire 138 on front surface 31f of first base material 31 is so set as to be greater than or equal to the projection area of heater wire 39 on back surface 131u of second base material 131. Although the pattern of conductive wire 138 and the pattern of heater wire 39 are substantially the same in FIG. 15, conductive wire 138 and heater wire 39 may have different patterns.

Controller 40 may be capable of detecting a touch on steering wheel 2 and causing heater wire 39 to emit heat simultaneously.

Meanwhile, electrode device 3d shown in FIG. 9 or electrode device 3e shown in FIG. 10 may be applied to electrode device 3i. In other words, as shown in FIG. 9, grip detecting electrodes 37 may be disposed distributedly on front surface 31f of first base material 31 between a plurality of ranges such that grip detecting electrodes 37 are electrically independent of each other. Furthermore, as shown in FIG. 10, a plurality of grip detecting electrodes 37 may be disposed on front surface 31f of first base material 31 in a state in which the plurality of grip detecting electrodes 37 are electrically integrated with each other as the plurality of grip detecting electrodes 37 are electrically connected to each other by wire connectors 37b.

Controller 40 and electrode device 3i configured as described above may constitute a measuring system provided in steering wheel 2.

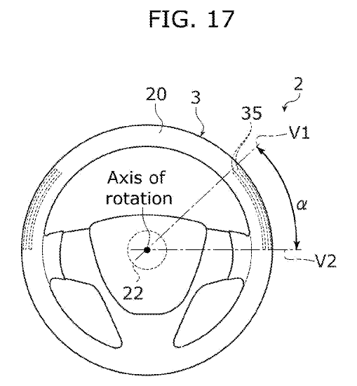

Next, as shown in FIG. 17, the range of rim 20 in which a pair of conductive elastomers 35 is disposed will be described.

FIG. 17 is a diagram showing the range of conductive elastomer 35 disposed on rim 20 in its neutral position.

As shown in FIG. 17, with the axis of rotation of rim 20 (the axis of hub 22) regarded as the center, angle α formed by dashed-dotted straight line V1 connecting each of one ends of the pair of conductive elastomers 35 and the axis of hub 22 and dashed-dotted straight line V2 connecting each of the other ends of the pair of conductive elastomers 35 and the axis may be set to greater than or equal to 30° and smaller than or equal to 90°.

It is to be noted that the content described above according to the present embodiment can be combined as appropriate.

### Workings and Advantageous Effects

Next, the workings and the advantageous effects of electrode devices 3 to 3i according to the present embodiment will be described.

For example, in a case in which the conductive rubber-coated fabric according to PTL 1 is to be mounted on the rim of a steering wheel, in one conceivable configuration, the conductive rubber-coated fabric is sewn to the surface of the steering wheel cover wrapped around the rim with sewing thread. When the driver grips the steering wheel, since the conductive rubber-coated fabric and the sewing thread are on the surface of the steering wheel cover, the design sophistication of the steering wheel may disadvantageously be reduced, or the accuracy of detecting the biometric information may disadvantageously be compromised as the driver’s hand is caught by the sewing thread and becomes unable to touch the conductive rubber-coated fabric.

Accordingly, as described above, electrode devices 3 to 3i according to technique 1 of the present embodiment are electrode devices 3 to 3i to be disposed on rim 20 of steering wheel 2 provided in vehicle 1, and electrode devices 3 to 3i include first base material 31 having a sheet form, first bonding layer 32 laminated on first base material 31, conductive base fabric 33 laminated on first bonding layer 32, second bonding layer 34 laminated on conductive base fabric 33, and conductive elastomer 35 laminated on conductive base fabric 33 so as not to overlap second bonding layer 34. Second bonding layer 34 is laminated with outer cover material 36 having formed therein slit 36a for exposing conductive elastomer 35, and conductive elastomer 35 is disposed in slit 36a.

According to this configuration, outer cover material 36 can form the exterior of steering wheel 2, and conductive elastomer 35 can be disposed in slit 36a formed in outer cover material 36. This configuration can make the surface of steering wheel 2 smooth and renders it unnecessary to sew a conductive rubber-coated fabric to the surface of a steering wheel cover with sewing thread as in the related art. Accordingly, the present embodiment can keep the design sophistication of steering wheel 2 from being reduced.

Furthermore, since the surface of steering wheel 2 is smooth, this configuration allows the driver to more easily grip steering wheel 2 and touch conductive elastomer 35 with his or her hand. The present embodiment thus makes a situation less likely in which sewing thread keeps the driver’s hand from touching a conductive rubber-coated fabric or the driver’s hand is caught by a conductive rubber-coated fabric and the accuracy of detecting the driver’s biometric information is compromised as a result, as in the related art.

Accordingly, electrode devices 3 to 3i according to the present disclosure can keep the design sophistication of steering wheel 2 from being reduced and keep the accuracy of detecting biometric information from being compromised.

In particular, since the surface of steering wheel 2 can be made smooth, this configuration is less likely to give the driver a sense of discomfort when the driver grips steering wheel 2, and thus the improvement in how the driver feels when touching steering wheel 2 can be expected.

In particular, if the hardness (the degree of hardness) of conductive elastomer 35 is made substantially the same as the hardness of outer cover material 36, the driver gripping steering wheel 2 is less likely to feel a sense of discomfort that could arise due to the difference in the material between conductive elastomer 35 and outer cover material 36.

Furthermore, the configuration in which conductive elastomer 35 is laminated on conductive base fabric 33 makes it possible to reduce the distance between conductive base fabric 33 and the driver’s hand as much as possible. Therefore, using conductive base fabric 33 having a lower electric resistance than conductive elastomer 35 makes it easier to obtain an electrical signal from the driver’s hand.

Meanwhile, electrode devices 3 to 3i according to technique 2 of the present embodiment are electrode devices 3 to 3i according to technique 1. In this case, conductive base fabric 33 is laminated on a portion of first bonding layer 32, and first bonding layer 32 is further laminated with outer cover material 36.

This configuration makes it possible to bond outer cover material 36 to an exposed portion of first bonding layer 32 and thus to secure outer cover material 36 in its place. Therefore, outer cover material 36 can be kept from becoming misaligned, and conductive elastomer 35 can be exposed through slit 36a.

Meanwhile, electrode devices 3 to 3i according to technique 3 of the present embodiment are electrode devices 3 to 3i according to technique 1 or 2. In this case, electrode devices 3 to 3i include a pair of conductive elastomers 35, one of the pair of conductive elastomers 35 being disposed toward the front of vehicle 1, the other of the pair of conductive elastomers 35 being disposed toward the rear of vehicle 1. The pair of conductive elastomers 35 is disposed on steering wheel 2 such that the outermost periphery of rim 20 passes between the pair of conductive elastomers 35.

According to this configuration, when electrode devices 3 to 3i are wrapped around rim 20, the stress exerted to each of the pair of conductive elastomers 35 can be expected to become uniform. In this case, the electrical characteristics of each of the pair of conductive elastomers 35 can be made identical, and the accuracy of detecting biometric information can be kept from being compromised.

Meanwhile, electrode device 3a according to technique 4 of the present embodiment is electrode device 3a according to any one of techniques 1 to 3. In this case, conductive elastomer 35 has a wavy line shape that extends in the direction in which rim 20 extends, and slit 36a in outer cover material 36 also has a wavy line shape that matches the wavy line shape of conductive elastomer 35.

This configuration makes it possible to secure a large area for conductive elastomer 35 disposed on steering wheel 2, and even if the driver’s hand gripping steering wheel 2 is shifted, the hand is more likely to remain in touch with conductive elastomer 35.

Meanwhile, electrode device 3b according to technique 5 of the present embodiment is electrode device 3b according to any one of techniques 1 to 4. In this case, conductive elastomer 35 is a layer having a belt shape that extends in the direction in which rim 20 extends, inclined surface 35a is formed at an end of conductive elastomer 35, and inclined surface 35a is laminated with outer cover material 36.

This configuration makes it possible to provide a step around the periphery of conductive elastomer 35 at the boundary between conductive elastomer 35 and outer cover material 36. Accordingly, acupoints on the driver’s hand gripping steering wheel 2 can be expected to be stimulated.

Meanwhile, electrode device 3b according to technique 6 of the present embodiment is electrode device 3b according to technique 5 that further includes outer cover material 36. Outer cover material 36 includes uneven structure 36b formed in the surface that the driver’s hand touches, and uneven structure 36b is disposed at a position that corresponds to the position of inclined surface 35a.

Since this configuration makes it possible to dispose uneven structure 36b at a position that corresponds to the position of inclined surface 35a, acupoints on the driver’s hand gripping steering wheel 2 can be expected to be stimulated.

Meanwhile, electrode devices 3 to 3i according to technique 7 of the present embodiment are electrode devices 3 to 3i according to any one of techniques 1 to 4. In this case, the surface of conductive elastomer 35 is flush with the surface of outer cover material 36.

According to this configuration, since the surface of steering wheel 2 can be made smooth, this configuration is less likely to give the driver a sense of discomfort when the driver grips steering wheel 2, and thus the improvement in how the driver feels when touching steering wheel 2 can be expected.

Furthermore, since this configuration allows the driver to sensorially recognize the boundary between conductive elastomer 35 and outer cover material 36 by touch, this configuration is expected to make the driver more aware of touching conductive elastomer 35 with his or her hand. Therefore, the driver’s biometric information can be expected to be obtained.

Furthermore, making the surface of conductive elastomer 35 flush with the surface of outer cover material 36 makes it possible to keep space from being formed at the boundary between conductive elastomer 35 and outer cover material 36. Therefore, even if the driver’s hand becomes sweaty, the sweat is less likely to enter between conductive elastomer 35 and outer cover material 36. As a result, this configuration can keep outer cover material 36 from peeling off and can thus keep electrode devices 3 to 3i from deteriorating.

Meanwhile, electrode devices 3d to 3i according to technique 8 of the present embodiment are electrode devices 3d to 3i according to any one of techniques 1 to 7 that further includes grip detecting electrode 37 for detecting a touch on steering wheel 2 by the driver’s hand. First bonding layer 32 is further laminated with grip detecting electrode 37.

This configuration makes it possible to determine whether the driver’s hand is gripping steering wheel 2. Therefore, while vehicle 1 is running, for example, the configuration above makes it possible to determine whether the driver’s hand is gripping steering wheel 2 properly.

Meanwhile electrode devices 3d to 3i according to technique 9 of the present embodiment are electrode devices 3d to 3i according to technique 8. In this case, the amount of deformation per unit area of conductive elastomer 35 produced by a tensile stress is smaller than the amount of deformation per unit area of grip detecting electrode 37 produced by this tensile stress.

According to this configuration, since conductive elastomer 35 stretches less easily than grip detecting electrode 37 when electrode devices 3d to 3i are stretched and wrapped around rim 20, conductive elastomer 35 can be kept from becoming misaligned.

Meanwhile, electrode devices 3d to 3i according to technique 10 of the present embodiment are electrode devices 3d to 3i according to technique 8 or 9 that further includes shield electrode 38 disposed on back surface 31u of first base material 31.

This configuration makes it possible to reduce the possibility that an electrostatic capacity is produced between grip detecting electrode 37 and metal core 23 of rim 20. Therefore, the accuracy of detecting the grip by the driver’s hand can be kept from being compromised.

Meanwhile electrode devices 3d to 3i according to technique 11 of the present embodiment are electrode devices 3d to 3i according to technique 10. In this case, the shield electrode is conductive wire 138, steering wheel 2 is provided with controller 40, and controller 40 drives, in a time-division manner, the function of detecting the touch on steering wheel 2 by the driver’s hand and the function of causing conductive wire 138 to emit heat.

This configuration makes it possible to detect with high accuracy the grip on steering wheel 2 by the driver’s hand and to warm the driver’s hand gripping steering wheel 2. Since this configuration renders it unnecessary to separately dispose heater wire 39 or an insulator between conductive wire 138 and heater wire 39, this configuration can keep the manufacturing cost of electrode devices 3d to 3i from increasing.

Meanwhile, electrode devices 3g to 3i according to technique 12 of the present embodiment are electrode devices 3g to 3i according to any one of techniques 1 to 9 that further includes heater wire 39 disposed on back surface 31u of first base material 31.

This configuration makes it possible to cause heater wire 39 to emit heat and thus to warm the driver’s hand gripping steering wheel 2.

Meanwhile, electrode devices 3g to 3i according to technique 13 of the present embodiment are electrode devices 3g to 3i according to technique 12. In this case, the density per unit area of heater wire 39 in the region in which heater wire 39 overlaps conductive elastomer 35 is smaller than the density per unit area of heater wire 39 in the region in which heater wire 39 does not overlap conductive elastomer 35.

This configuration can keep the temperature of heater wire 39 in the region in which heater wire 39 overlaps conductive elastomer 35 from becoming lower than the temperature of heater wire 39 in the region in which heater wire 39 does not overlap conductive elastomer 35. This configuration thus makes it possible to reduce a fluctuation in the overall temperature of steering wheel 2 that could be caused by conductive elastomer 35 that conducts heat readily. With this configuration, the overall temperature of steering wheel 2 can be expected to be kept uniform.

Meanwhile, electrode devices 3h and 3i according to technique 14 of the present embodiment are electrode devices 3h and 3i according to any one of techniques 1 to 9 that further include heater wire 39, shield electrode 38, and second base material 131. Shield electrode 38 and second base material 131 are disposed on back surface 31u of first base material 31, shield electrode 38 is sandwiched between first base material 31 and second base material 131, and heater wire 39 is disposed on second base material 131 on the side opposite to the side on which shield electrode 38 is disposed.

This configuration makes it possible to cause heater wire 39 to emit heat and thus to warm the driver’s hand gripping steering wheel 2.

The configuration above also makes it possible to reduce the possibility that an electrostatic capacity is produced between grip detecting electrode 37 and metal core 23 of rim 20. Therefore, the accuracy of detecting the grip by the driver’s hand can be kept from being compromised.

Meanwhile, electrode devices 3 to 3i according to technique 15 of the present embodiment are electrode devices 3 to 3i according to any one of techniques 1 to 14 that include a pair of conductive base fabrics 33, a pair of second bonding layers 34, and a pair of conductive elastomer 35. First base material 31 includes base material spoke portion 31b disposed along rim 20 and a pair of base material spoke portions 31b that extends from base material rim portion 31a toward spoke 30 of steering wheel 2. First bonding layer 32 includes first bonding rim portion 32a laminated on base material rim portion 31a and a pair of first bonding spoke portions 32b laminated, one to one, on the pair of base material spoke portions 31b. Each of the pair of conductive base fabrics 33 includes base fabric rim portion 33a laminated on first bonding rim portion 32a and a pair of base fabric spoke portions 33b laminated, one to one, on the pair of first bonding spoke portions 32b. The pair of second bonding layers 34 is laminated, one to one, on the pair of base fabric spoke portions 33b. The pair of conductive elastomers 35 is laminated, one to one, on the pair of base fabric rim portions 33a. Outer cover material 36 has formed therein a pair of slits 36a for exposing, one to one, the pair of conductive elastomers 35.

This configuration makes it possible to extend the pair of base material spoke portions 31b from rim 20 to spoke 30 and thus to electrically connect the pair of base material spoke portions 31b and wire 49 at spoke 30. This configuration, therefore, renders it unnecessary to dispose wire 49 on rim 20 and can keep the driver from feeling a sense of discomfort when gripping steering wheel 2.

### Other Variations

Thus far, electrode devices according to the present disclosure have been described based on the foregoing embodiment, but this embodiment does not limit the present disclosure. Unless departing from the spirit of the present disclosure, an embodiment obtained by making various modifications that a person skilled in the art can conceive of to the embodiment may also be encompassed by the scope of the present disclosure.

It is to be noted that an embodiment obtained by making various modifications that a person skilled in the art can conceive of to the embodiment and an embodiment achieved by combining, as desired, the constituent elements and the functions of the foregoing embodiment within the scope that does not depart from the spirit of the present disclosure are also encompassed by the present disclosure.

### Further Information about Technical Background to this Application

The disclosure of the following patent application including specification, drawings, and claims, is incorporated herein by reference in its entirety: Japanese Patent Application No. 2025-010044 filed on January 23, 2025.

### Industrial Applicability

The present disclosure is useful for a steering wheel to be provided in a vehicle.

1. An electrode device to be disposed on a rim of a steering wheel provided in a vehicle, the electrode device comprising:
a first base material having a sheet form;
a first bonding layer laminated on the first base material;
a conductive base fabric laminated on the first bonding layer;
a second bonding layer laminated on the conductive base fabric; and
a conductive elastomer laminated on the conductive base fabric, the conductive elastomer not overlapping the second bonding layer, wherein
the second bonding layer is laminated with an outer cover material having formed therein a slit for exposing the conductive elastomer, and
the conductive elastomer is disposed in the slit.

2. The electrode device according to claim 1, wherein
the conductive base fabric is laminated on a portion of the first bonding layer, and
the first bonding layer is further laminated with the outer cover material.

3. The electrode device according to claim 1, comprising:
a pair of conductive elastomers, each of which is the conductive elastomer, one of which is disposed to face toward a front of the vehicle, one of which is disposed to face toward a rear of the vehicle, wherein
the pair of conductive elastomers is disposed on the steering wheel with an outermost periphery of the rim passing between the pair of conductive elastomers.

4. The electrode device according to claim 1, wherein
the conductive elastomer is formed in a wavy line shape that extends in a direction in which the rim extends, and
the slit in the outer cover material is also formed in a wavy line shape that matches the wavy line shape of the conductive elastomer.

5. The electrode device according to claim 1, wherein
the conductive elastomer is a layer having a belt shape that extends in a direction in which the rim extends,
an inclined surface is formed at an end of the conductive elastomer, and
the inclined surface is laminated with the outer cover material.

6. The electrode device according to claim 5, further comprising:
the outer cover material, wherein
the outer cover material includes an uneven structure formed on a surface that a hand of a driver touches, and
the uneven structure is disposed at a position corresponding to a position of the inclined surface.

7. The electrode device according to claim 1, wherein
a surface of the conductive elastomer is flush with a surface of the outer cover material.

8. The electrode device according to claim 1, further comprising:
a grip detecting electrode for detecting a touch on the steering wheel by a hand of a driver, wherein
the first bonding layer is further laminated with the grip detecting electrode.

9. The electrode device according to claim 8, wherein
an amount of deformation per unit area of the conductive elastomer produced by a tensile stress is smaller than an amount of deformation per unit area of the grip detecting electrode produced by the tensile stress.

10. The electrode device according to claim 8, further comprising:
a shield electrode disposed on a back surface of the first base material.

11. The electrode device according to claim 10, wherein
the shield electrode is a conductive wire,
the steering wheel includes a controller, and
the controller drives, in a time-division manner, a function of detecting the touch on the steering wheel by the hand of the driver and a function of causing the conductive wire to emit heat.

12. The electrode device according to claim 1, further comprising:
a heater wire disposed on a back surface of the first base material.

13. The electrode device according to claim 12, wherein
a density per unit area of the heater wire in a region in which the heater wire overlaps the conductive elastomer is smaller than a density per unit area of the heater wire in a region in which the heater wire does not overlap the conductive elastomer.

14. The electrode device according to claim 1, further comprising:
a heater wire;
a shield electrode; and
a second base material, wherein
the shield electrode and the second base material are disposed on a back surface of the first base material,
the shield electrode is sandwiched between the first base material and the second base material, and
the heater wire is disposed on the second base material on a side opposite to a side on which the shield electrode is disposed.

15. The electrode device according to claim 1, comprising:
a pair of conductive base fabrics, each of which is the conductive base fabric;
a pair of second bonding layers, each of which is the second bonding layer; and
a pair of conductive elastomers, each of which is the conductive elastomer, wherein
the first base material includes a base material rim portion disposed along the rim, and a pair of base material spoke portions that extends from the base material rim portion toward respective spokes of the steering wheel,
the first bonding layer includes a first bonding rim portion laminated on the base material rim portion, and a pair of first bonding spoke portions laminated, one to one, on the pair of base material spoke portions,
each of the pair of conductive base fabrics includes a base fabric rim portion laminated on the first bonding rim portion, and a pair of base fabric spoke portions laminated, one to one, on the pair of first bonding spoke portions,
the pair of second bonding layers is laminated, one to one, on the pair of base fabric spoke portions,
the pair of conductive elastomers is laminated, one to one, on the pair of base fabric rim portions, and
the outer cover material has formed therein a pair of slits for exposing, one to one, the pair of conductive elastomers.
